(19) United States
(12) Patent Application Publication
(10) Pub. No.: US 2011/0177739 A1
(43) Pub. Date: Jul. 21, 2011

(54) GLUE LINE MATERIAL FOR WOOD BOARD AND WOOD BOARD

(75) Inventors: Samantha Kiljunen, Lappeenranta (FI); Raija Rautiainen, Lahti (FI); Mizanur Bulbul, Lahti (FI); Milla Hintikka, Lahti (FI); Simo Koponen, Lahti (FI)

(73) Assignee: UPM-Kymmene Wood Oy, Lahti (FI)

(21) Appl. No.: 13/120,500

(22) PCT Filed: Aug. 17, 2009
(86) PCT No.: PCT/FI2009/050662

§ 371 Date: Mar. 23, 2011

(30) Foreign Application Priority Data
Sep. 23, 2008 (FI) 20085897
Sep. 23, 2008 (FI) 20085898

(51) Int. Cl. B32B 21/08; B32B 7/12; B32B 27/12

(52) U.S. Cl. 442/290; 428/354; 442/398; 428/513

(57) ABSTRACT

The invention relates to a glue line material for a wood board. In accordance with the invention,the glue line material is formed of at least first film layer (3), and the film comprises at least three film layers and at least outer film layers contain polyolefin and a coupling agent which is reactive with —OH groups of the wood for forming self-adhesive properties to make the glue line material self adhesive to —OH groups of the wood.

### FIELD OF THE INVENTION

The invention relates to a glue line material as defined in the preamble of claim 1 and a wood board as defined in the preamble of claim 18.

### BACKGROUND OF THE INVENTION

Known from prior art are various wood boards, e.g. plywoods, veneer boards or the like.

Known from prior art are various glues for gluing the veneers together to form a wood board. Also known is to glue coating layers on top of the veneer layers, e.g. with a polyurethane or phenolic glue.

Known from prior art is the gluing of different types of adhesive labels or product specifications onto the surface of the wood board in a separate working phase to provide product information.

From U.S. Pat. No. 5,243,126, U.S. Pat. No. 5,654,091, EP0782917, WO 9906210 and EP 0429253 different wood panels and adhesive materials are known.

Patent publication WO 03/033252 discloses a composite material comprising two layers in which the first layer is formed of high strength fibers and resin and the second layer is structural sheathing e.g. plywood. The high strength fibers are selected from the group consisting of aramid fibers, glass fibers, polyethylene fibers, polyvinyl alcohol fibers, polyarylate fibers, polybenzazole fibers, or carbon fibers.

### OBJECTIVE OF THE INVENTION

The objective of the invention is to disclose a new type of glue line material, its production and the attachment of the material to a wood board. Further, the objective of the invention is to disclose conversion of the coupling agent to an active form for forming the material and for attaching the material on the wood board.

### SUMMARY OF THE INVENTION

A glue line material and a wood board according to the invention is characterized by what is presented in the claims.

The invention is based on a glue line material for a wood board. According to the invention the glue line material is formed of at least first layer formed of a film, and the film comprises at least three film layers and at least outer film layers contain polyolefin and a coupling agent which is reactive with —OH groups of the wood for forming self-adhesive properties to make the glue line material self adhesive to —OH groups of the wood.

The invention is specifically based on the glue line material having certain properties and structure. The layers of the glue line material are substantially joined together by the coupling agent which is reactive with —OH groups of the wood, preferably via esterification, for forming self-adhesive properties, e.g. by maleic anhydride polyolefin. The glue line material is used as a glue line and/or a coating in conjunction with the wood board.

In this context, a wood board refers to any wood panel product, plywood product, composite product, beam, pressed panel product or the like, formed of a number of layers, preferably veneer layers, and principally of wood-based materials, in which the layers are laid one upon the other and glued together. Further, a wood board refers to any wood product or fiber product.

In this context, a layer refers to any layer of material, typically a thin layer of material.

In one embodiment the first layer is a bottom layer.

In one embodiment of the invention the glue line material comprises the top layer arranged on the first layer. In one embodiment of the invention the top layer is a protective layer. Preferably the top layer provides the protection for the other layers.

In one embodiment of the invention the glue line material comprises at least one middle layer arranged between the first and the top layers. In one embodiment the middle layer is arranged between the first and top layers for providing a protected middle layer. The glue line material can comprise more than one middle layer.

In one embodiment of the invention the glue line material comprises reinforcement fibers.

In one embodiment of the invention the glue line material comprises at least one reinforcement layer. In one embodiment the glue line material comprises at least two reinforcement layers. In one preferred embodiment the coupling agent is reactive with —OH groups of the reinforcement layer or reinforcement fibers.

In one embodiment of the invention the film of the first layer is a multi-layer film containing more than three film layers.

In one embodiment of the invention the top layer is formed a film.

In one embodiment of the invention the middle layer is formed a film.

In one embodiment of the invention the film is a 2-layer film. In one embodiment the film is a 3-layer film. In one embodiment the film is a multi-layer film comprising more than three film layers, e.g. 3-11 film layers.

Preferably the layers and the film layers are joined together by means of the coupling agent, e.g. by maleic anhydride polyolefin. Preferably, the film is the self-adhesive film provided by the coupling agent which reacts with —OH groups in other material e.g. natural products like wood or wood derivative products.

In one embodiment of the invention at least one layer of the film contains the coupling agent.

In a preferred embodiment the layer, the film or the film layer which includes the coupling agent also contains polymer e.g. polyethylene or polypropylene.

In one embodiment of the invention the coupling agent is selected from the group: grafted silanes, grafted isocyanates, grafted epoxy groups and maleic anhydride polyolefin, e.g. maleic anhydride grafted polypropylene (MAPP), maleic anhydride grafted copolymer and maleic anhydride grafted polyethylene (MAPE).

In one embodiment maleic anhydride polyolefin used is maleic anhydride polyethylene (MAPE) and/or maleic anhydride polypropylene (MAPP). Preferably, the film layer including maleic anhydride polyolefin essentially consists of MAPE+PE or MAPP+PP. In one embodiment the film contains 2-15% w/w maleic anhydride.

In one embodiment the coupling agent or polyolefin of the coupling agent or the film containing coupling agent is grafted with alkoxysilane containing reactive functional groups with the polyolefin. In one embodiment the polyolefin is grafted with hydrolysable vinyl-mono-, -di- or -tri-alkoxysilane. In one embodiment vinyl group can be replaced with isosyanate- or epoxy groups. Alkoxysilanes alcohol groups can be methyl-, ethyl-, propyl- or isopropyl-groups and silane can contain 1,2 or 3 alkoxy-groups. The reaction with polyolefin with the vinyl or other reactive groups happens already during the manufacturing of the coupling material, and reaction with wood by silane-groups during or after the manufacturing of the wood board.

Preferably the coupling agent forms covalent bonds, ester bonds and/or covalent bonds via esterification with celluloses —OH groups. In one embodiment the coupling agent forms covalent bonds via esterification with celluloses —OH groups.

In one embodiment of the invention the coupling agent is activated at temperatures of more than 180° C. during the manufacture of the coupling material. The coupling material can be manufactured by co-extrusion. Also other extrusion methods are possible. The extrusion temperature is between 180-200° C. In a preferred embodiment an extrusion melt temperature of 200° C. for 2 minutes is employed, which is sufficient time to convert the coupling agent to a reactive form. The coupling agent formed contains activated functional groups capable of forming the maximum number of covalent and/or ester bonds with —OH groups of wood. The melt index of the polyolefin being 4 g/10 min (measured 190° C/2.16 kg) makes the activation of the reactive groups possible in film form.

In a preferred embodiment of the invention the layers are joined together by means of the maleic anhydride polyolefin. The maleic anhydride forms covalent bonds, preferably covalent bonds via esterification, with celluloses —OH groups.

Preferably, maleic acid is converted to maleic anhydride during the film manufacturing. The film can be manufactured by co-extrusion of the polyolefin and maleic anhydride grafted polyolefin. Also other extrusion methods are possible. The extrusion temperature is between 180-200° C. In a preferred embodiment of the coating process an extrusion melt temperature of 200° C. for 2 minutes is employed, which is sufficient time to convert the coupling agent from maleic acid to maleic anhydride. The film formed contains activated functional groups capable of forming the maximum number of covalent bonds with —OH groups of wood. In one embodiment maleic anhydride conversion is more than 86% and unconverted maleic acid conversion is less than 14% in the film or in the layer of the film containing the maleic anhydride polyolefin. In one preferred embodiment maleic anhydride conversion is more than 92% and unconverted maleic acid conversion is less than 8%.

In one embodiment of the invention the top and/or middle layer contains polyolefin and the coupling agent.

In one embodiment of the invention the first, middle and/or top layer contains polyethylene (PE), polypropylene (PP), high density polyethylene (HDPE), medium density polyethylene (MDPE), high molecular weight polyethylene (HMWPE), ultra high molecular weight polyethylene (UHMWPE), the coupling agent, e.g. maleic anhydride polyethylene (MAPE) or maleic anhydride polypropylene (MAPP), metallocene produced polyethylene (TIE) and/or derivates thereof or their combinations. The layer can include additives and fillers. In a preferred embodiment the TIE-material includes the coupling agent.

In one embodiment of the invention the first, top and/or middle layer contains polyolefin having melt flow index in the range 0.1-4 g/10 min and DSC melting temperature in the range of 100-140° C.

In one embodiment polymers with low viscosity are used in the outer layers of the 2-layer and S-layer films. In one embodiment of the invention the layer contains polyolefin having melt flow index (MFI) in the range 0.3-4 g/10 min (measured at 2.16 kg and 190° C.) and DSC (Differential scanning calorimeter) melting temperature in the range of 100-140° C. In one a preferred embodiment this polyolefin is used in the outer layers of the first and top layer to improve penetration of the outer surfaces into the wood. In one embodiment this polyolefin is used in the mono film to aid in adhesion of the middle layer to the reinforcement material.

The creep resistance of the polymers can be improved by using polymers of high molecular weight in the middle layer or the middle film layer. In one embodiment the middle layer has the following structure MAPE+LDPE/HDPE/LDPE+MAPE, MAPE+LDPE/HDPE/HDPE, MAPE+LDPE/HDPE/MDPE, MAPE+LDPE/HDPE+MAPE/LDPE+MAPE, MAPE+LDPE/MDPE/LDPE+MAPE, MAPE+LDPE/MDPE+MAPE/LDPE+MAPE or MAPP+PP/PP/MAPP+PP. In one embodiment the molecular weight of the polymer is >100000 and preferably between 100 000-500 000. The MFI of a polymer is inversely related to its molecular weight and therefore polymers with a low MFI (in the range of 0.1-1.0 g/10 min, measured at 21.6 kg and 190° C.) have a high molecular weight. In one embodiment polyethylene density affects on the creep resistance and therefore the density of polymer used in the middle layer is in the range of 0.940-0.965 g/cm³.

In one embodiment any polyolefin film can contain mineral fillers e.g. PCC or aluminium oxide, preferably in amount 1-15% of film volume.

In one embodiment any polyolefin used is cross-linked. By the cross-linking of the polyolefin the creep resistance can be improved. Further, the creep resistance can be improved by addition of MAPP and/or MAPE coupling agent to the layers.

In one embodiment of the invention the reinforcement layer can contain different reinforcement fibers and polymers. The reinforcement layer can contain woven textile, non-woven textile, woven fiber, non-woven fiber, oriented or non-oriented fiber material, organic fiber, glass fiber, carbon fiber, nylon 66, aramid, natural fiber e.g. flax, cotton, viscose-pulp or hemp fiber and/or derivates thereof or their combinations. Further, in a preferred embodiment, the reinforcement layer contains polyolefin, e.g. polyethylene or polypropylene, a coupling agent, e.g. maleic anhydride polyolefin, and/or TIE which are preferably a support material of the reinforcement layer. The polymer can be polyolefin or its copolymer or known biopolymer like lactic acid polymer, poly-glyconate or poly-peptide. In one embodiment the glue line material can be reinforced with polymer fibers having a higher melting point than polyethylene, polypropylene or their copolymers.

In one embodiment the reinforcement layer is arranged in conjunction with the middle layer e.g. beside the middle layer. In one embodiment the reinforcement layer is arranged between the first and middle layers. In one embodiment the reinforcement layer is arranged between the middle and top layers. In one embodiment the reinforcement layer is arranged between two middle layers. In one embodiment alternating reinforcement and middle layer constructions are formed with up to 4 middle layers and 5 reinforcement layers.

In one embodiment, the reinforcement layer is formed by co-extruding the reinforcement fibers into the support polymer.

The creep resistance of polymers can be improved by the reinforcement fibers. At same time the bending strength can be substantially improved.

The fibers loaded to polymers during extrusion are more or less oriented depending on fiber length and extrusion conditions. Textiles, placed between two films, can be oriented in structures as required by the end-product.

In one embodiment at least one film layer of the glue line material contains the coupling agent. In one embodiment all the film layers of the film contain the coupling agent. In one embodiment the outer film layers of the film contains the coupling agent.

In a preferred embodiment of the invention the layers are joined together and the glue line material is attached onto the surface of the veneer by means of the coupling agent. The coupling agent forms covalent bonds via esterification between two layers or films or materials. Adhesion can be further improved by using the polymers of low viscosity (MFI 0.3-4 g/10 min, measured at 2.16 kg and 190° C.) and DSC melting temperature of 100-130° C. in the outer film layers for providing greater penetration into the wood. The maleated polyolefins can be used in all film layers, which is advantageous for films 0.1 mm thick and necessary for thinner films <0.1 mm.

Penetration of the films into the wood can be improved by applying shear, e.g. rolling, vibration or rotating, during hot-pressing (standard or continuous press) at the point when the polymers are in the molten state. The shear will result in a drop in the viscosity.

Preferably, the first and the third layers penetrate into the porous reinforcement layer for forming a strong composite laminate.

In one embodiment at least one film layer is formed of the thermoplastic material.

The layer, film or film layer can be made from petrochemical and renewable feedstock materials. In addition bioplastic material, preferably the bio-based polymers having processing temperature over 180° C. or over 190° C., can be used.

In one embodiment the glue line material comprises an RFID-identifier or RF-tag. In one embodiment, the glue line material comprises electrically conductive material, e.g. carbon fibers or thin metallic fibers. An electrically conductive layer is used on table tops or for heating purposes. The RFID-identifier, RF-tag or electrically conductive material can be placed in the middle layer or the reinforcement layer.

The layer or at least one film layer of the layer can be printed, painted and/or pigmented.

In one embodiment, all film layers of said layer are substantially formed of the same material. In an alternative embodiment, at least one film layer of said layer is formed of a different material than the other film layers.

The layer thickness of the glue line material may vary depending on the properties of the film materials and the application of the wood board.

A compatibilizing agent can be added to any layer in order to adhere the dissimilar polymers to each other. When dissimilar polymers are co-extruded a compatibilizing agent is required in the reinforcement layer to join the dissimilar materials.

Further, the invention is based on a wood board, which comprises the glue line material according to the invention as defined above.

A wood board according to the invention can comprise veneer layers of different thickness. The thicknesses of the veneer layers can vary. The veneer layers can be arranged in the desired position, i.e. crosswise or lengthwise in the desired order.

The wood board can be made using apparatuses and methods known per se. Laying the veneers one upon the other, joining them together and other typical steps in making the wood board can be performed in any manner known per se in the art.

In one embodiment the glue line material is arranged between the veneers of the wood board. In one embodiment the glue line material is arranged as a coating onto the wood board. In a preferred embodiment the glue line material has been attached in conjunction with the wood board by the coupling agent.

In one embodiment the glue line material between each veneer comprises reinforcement fibers. In one embodiment the glue line material between one or more veneers comprises fibers but the other glue lines consist of only polyolefin-based films. In one embodiment the fiber-film is arranged to replace veneer raw material. This is especially the case when the fiber-film provides increased strength and bending properties equal and greater to that of a veneer.

Arranging the glue line material of the invention on the surface of the veneer or the wood board can be performed e.g. using the hot pressing technique, extruder technique, film technique, roll application technique, cylinder application technique, coat and multi-layer coat application technique, all known per se, their combinations or a corresponding technique. The veneers can be joined together e.g. using the hot pressing technique.

The glue line material of the invention can be prelaminated to make handling easier and more economical.

The coupling agents, e.g. maleated polymers, are cheap and nontoxic and they form chemical bonds that are less susceptible to hydrolysis. The defined coupling agent is easy to use as a glue line. Adhesion on wood is excellent.

The fiber-film between the veneer plies improves the bending strength for building applications. The middle layer with reinforcement fibers improves also resistance against projectiles or high point loads.

The glue line material and the wood board in accordance with the invention are suitable for various applications. These kinds of materials and products can be used in conjunction with different structures e.g. doors, window protector covers, vehicle floors and vibration change structures.

### LIST OF FIGURES

In the following, the invention is described by means of detailed embodiment examples with reference to accompanying FIGS. 1a, 1b, 2 and 3, in which

FIGS. 1a, 1b and 2 show glue line materials according to the invention,

FIG. 3 shows a method for making the glue line material according to the invention, and

FIG. 4 shows the ATR spectroscopy results.

### DETAILED DESCRIPTION OF THE INVENTION

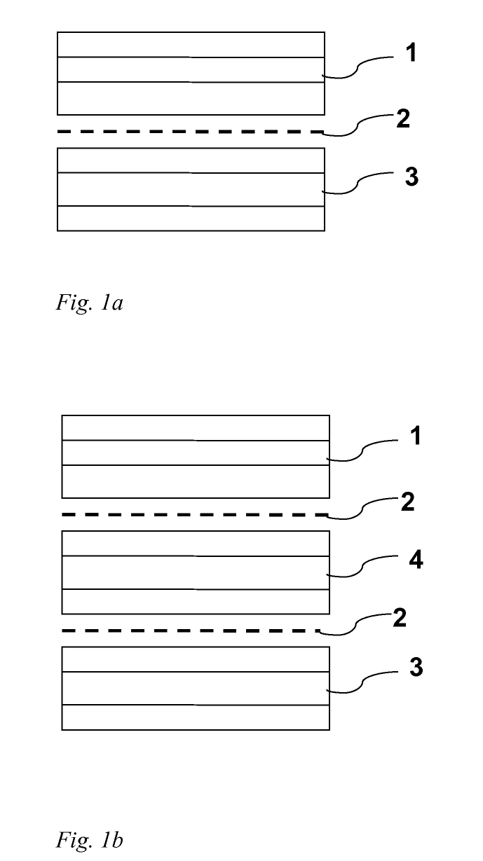

FIGS. 1a and 1b disclose the glue line material structures of the invention. The glue line material is a fiber-polymer laminate.

A top layer (1) is formed of a 3-layer film which is PE/PE/MAPE+PE, MAPE+PE/PE/MAPE+PE, MAPE+PE/HDPE/MAPE+PE, MAPE+PE/MAPE+PE/MAPE+PE, MAPE+PE/MDPE/MAPE+PE, MAPE+PE/HMWPE/MAPE+PE, MAPE+PE/UHMWPE/MAPE+PE, MAPP+PP/PP/MAPP+PP, MAPP+PP/MAPP+PP/MAPP+PP, PP/MAPP+PP/MAPP+PP, PP/PP/MAPP+PP, PP/TIE/MAPE+PE, PA/TIE/MAPE+PE, PET/TIE/MAPE+PE or MAPP+PP/TIE/MAPE+PE. The thickness of the top layer is 0.05-1 mm.

The middle layers (4) are formed of 3-layer film which is MAPE+PE/PE/MAPE+PE, MAPE+PE/HMWPE/PE, MAPE+PE/HDPE/MAPE+PE, MAPE+PE/MAPE+PE/MAPE+PE, MAPP+PP/PP/MAPP+PP, MAPE+PE/HDPE+MAPE/MAPE+PE, MAPE+PE/MDPE+MAPE/MAPE+PE, MAPE+PE/UHMWPE+MAPE/MAPE+PE, MAPE+PE/MDPE+MAPE/MAPE+PE, MAPE+PE/MDPE/MAPE+PE, MAPE+PE/HMWPE/MAPE+PE, MAPE+PE/UHMWPE/MAPE+PE, MAPP+PP/MAPP+PP/MAPP+PP, PP/TIE/MAPE+PE or MAPP+PP/TIE/MAPE+PE. The thickness of the top layer is 0.05-1 mm.

The reinforcement layers (2) are formed of flax, hemp, viscose-cellulose, cotton, polyvinyl-alcohol, nylon 66, aramid or glass-fiber. Further the reinforcement layers can include PE, PP, MAPE, MAPP and/or TIE. The reinforcement layers are attached to the outer surfaces of the middle layer. The reinforcement fiber material has melting point over melting points of the polyolefins of the middle layer. The thickness of the reinforcement layer is at least 0.05-1 mm but it can be more. The reinforcement material can consist of PE/PE+Fibres+MAPE/MAPE+PE, PP/PP+Fibres+MAPP/MAPP+PP, PP/TIE+Fibres/MAPE+PE, MAPE+PE/PE+Fibres+MAPE/MAPE+PE, MAPP+PP/PP+Fibres+MAPP/MAPP+PP.

The combination of the middle layer (4) and the reinforcement layer (2) can consist of reinforcement layer/middle layer up to 9 layers.

A bottom layer (3) is formed of 3-layer film which is MAPE+PE/PE/MAPE+PE, MAPE+PE/MAPE+PE/MAPE+PE, MAPE+PE/HDPE/MAPE+PE, MAPE+PE/MDPE/MAPE+PE, MAPE+PE/HMWPE/MAPE+PE, MAPE+PE/UHMWPE/MAPE+PE, MAPP+PP/PP/MAPP+PP, MAPP+PP/TIE/MAPE+PE or MAPP+PP/MAPP+PP/MAPP+PP. The thickness of the bottom layer is 0.1-1 mm.

The middle layers are sandwiched between the top layer and the bottom layer. All the layers are self adhesive films and include maleic anhydride polyolefins like MAPE and/or MAPP. The reinforcement layers (2) are sandwiched between the top (1) and middle (4) layers or alternating middle (4) layers.

The final reinforcement layer (2) is sandwiched between the middle (4) and the bottom (3) layer. The combination of the middle layer (4) and the reinforcement layer (2) can consist of 3-9 alternating layers of layers (2) and (4).

At least one film layer or one layer can include additives and/or fillers. At least one film layer or one layer can be pigmented, painted or printed.

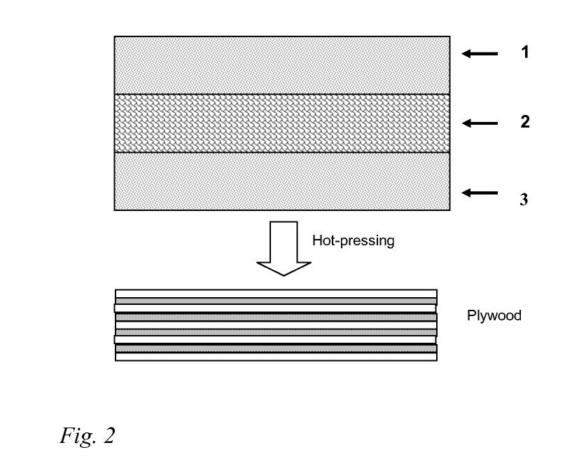

FIG. 2 discloses the second glue line material structure of the invention. The glue line material is formed by co-extruding so that the polymer film layers and reinforcement layer with reinforcement fibers and polymers are co-extruded to form the reinforced glue line film material.

The glue line material can consist of a) MAPE+PE(1)/PE+fibres+MAPE(2)/MAPE+PE(3); b) MAPE+PE(1)/PE+fibres+MAPE(2)/MAPE+PE(3); or c) MAPP+PP(1)/Tie+fibres(2)/MAPE+PE(3). In these preferred compositions maleated polyolefins are used in all three layers. The outer layers provide adhesion to the wood and the middle layer encapsulates the fibres in the polymer. The thickness of all layers is between 0.05-1 mm.

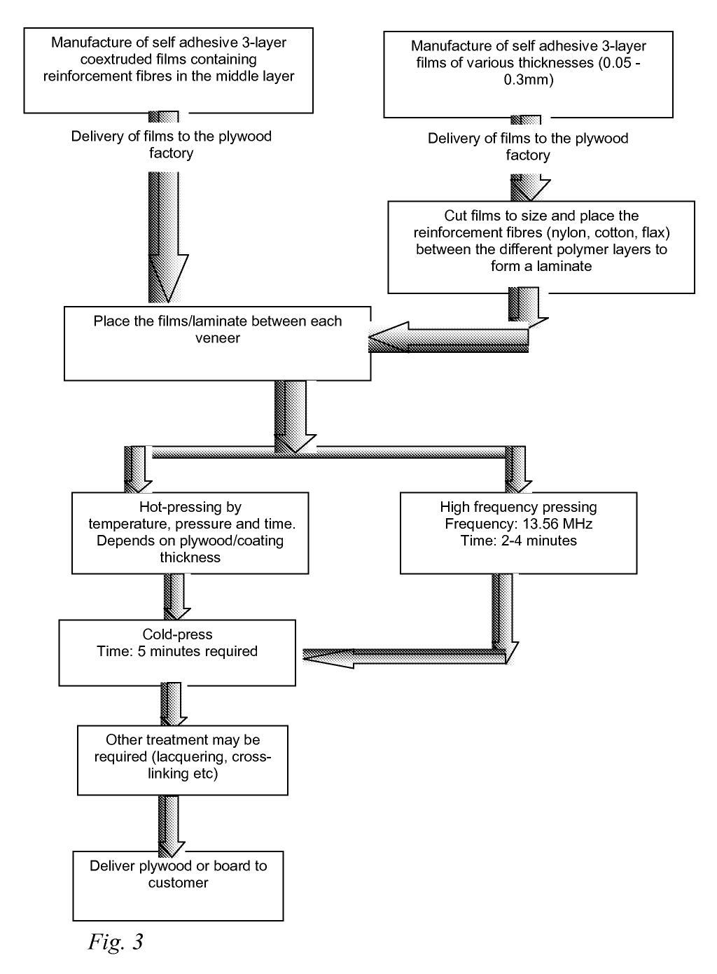

Further, wood boards used in the tests were prepared according to FIG. 3. As the wood board can be used plywood, particle board, high or middle density fiberboard, or some other pressed and glued board containing wood or other plant fibers.

The maleated polyolefin contains normally 2-15% maleic acid of the amount of polyolefin. At extrusion the maleic acid is converted to maleic anhydride, partially or totally. The polymer film can also be cross-linkable if it in any way improves the use of the products. The maleated films are pressed at temperature 120-170° C. to the wood surface and to the other films and layers. It is important in order to include plastic melt flow that the hot-pressing temperature is set to a temperature 20-50° C. above the melting temperature of the polymer. The top layer can be cross-linked by vinyl-silane hydrolysis method or electron beam (EB) radiation. Each polymer film can contain also fillers like PCC (Precipitated Calcium Carbonate) or aluminium oxide etc. up to 30% of the polymer volume.

The fiber content, when mixed in the extruder, can be from 1 to 40% by volume. Greater than 40% may result in a brittle material. Fibers arranged separately between polymer film layers can be 20-120 g/m².

The glue line material can be arranged by hot-pressing onto the veneer of the wood board in a manner known per se.

From the test it was discovered that the material of the invention is a suitable glue line material to be used as a glue line or as a coating in wood boards.

### EXAMPLE 1

In this example, the reinforcement glue line materials of the invention and the reinforcement materials were tested.

Table 1 shows the tensile strength (EN789) and modulus of elasticity (MOE) of the modified thermoplastic films. The MOE was calculated from 10-40% of the maximum force. The cross-head distance was mm and sample size 50×250 mm. The radiation sensitive film had much better tensile strength properties after radiation. Cross-linking of polyethylene by radiation treatment appeared to damage slightly the mechanical properties of the films. The polymer density, which was to be expected, had a significant effect on the stiffness of the polymer.

TABLE 1

| | Cross- | Mechanical properties | |
|---|---|---|---|
| | linking | | Tensile |
| Middle reinforcement | dosage | MOE | strength |
| material | (kGy) | (N/mm²) | (N/mm²) |
| 2% MAPE + MI-0.3PE/ | 150 (100) | 437.1 (416.8) | 13.6 (13.0) |
| MI-0.5HDPE/ | | | |
| 2% MAPE + MI-0.3PE | | | |
| (radiation sensitive | | | |
| HDPE) | | | |
| 2% MAPE + MI-0.3PE/ | 200 | 374.9 | 13.0 |
| MI-0.2HDPE/ | | | |
| 2% MAPE + MI-0.3PE | | | |
| 2% MAPE + MI-0.3PE/ | 200 | 285.9 | 10.3 |
| MI-0.4MDPE/ | | | |
| 2% MAPE + MI-0.3PE | | | |
| 2% MAPE + MI-0.3PE/ | 150 | 191.6 | 8.6 |
| MI-0.3PE/ | | | |
| 2% MAPE + MI-0.3PE | | | |
| 2% MAPE + MI-0.3PE/ | — | 291.4 | 10.5 |
| MI-0.4MDPE/ | | | |
| 2% MAPE + MI-0.3PE | | | |
| 2% MAPE + MI-0.3PE/ | — | 357.2 | 11.3 |
| MI-0.2HDPE/ | | | |
| 2% MAPE + MI-0.3PE | | | |
| 2% MAPE + MI-0.3PE/ | — | 191.9 | 8.4 |
| MI-0.3PE/ | | | |
| 2% MAPE + MI-0.3PE | | | |
| 3% MAPE + MI-0.2HDPE/ | — | 926.6 | 21.4 |
| MI-0.2HDPE/ | | | |
| 3% MAPE + MI-0.2HDPE | | | |

MI is the melt index of a polymer. It is a measure of the melt viscosity, but it is the inverse of real viscosity.

Table 2 shows the tensile strength (EN789) and modulus of elasticity (MOE) of different fiber materials. The MOE was calculated from 10-40% of the maximum force. The cross-head distance was 10 mm and sample size 50×250 mm. The radiation sensitive film had much better tensile strength properties after radiation. The materials had varying mechanical properties. The material with the best tensile properties was not necessary the one with the highest MOE. The flax materials (woven) had the highest tensile strength properties but the glass fiber non-woven material as the best MOE.

TABLE 2

| Fibre | TS | MOE | Thickness | Width |
|---|---|---|---|---|
| material | (N/mm²) | (N/mm²) | (mm) | (±1 mm) |
| Glass fibre (30 g/m²) | 8.32 | 620.12 | 0.22 | 50 |
| non woven | | | | |
| Glass fibre (80 g/m²) | 10.6 | 730.55 | 0.51 | 50 |
| non woven | | | | |
| Train paper | 8.47 | 181.29 | 0.17 | 50 |
| Textile (Viscose + | 10.09 | 317.45 | 0.12 | 50 |
| cellulose) | | | | |
| Textile | 14.96 | 88.55 | 0.56 | 50 |
| Colback S90, Non woven | 10.98 | 91.26 | 0.44 | 50 |
| polyester | | | | |
| Colback SNS 75, Non | 9.49 | 216.33 | 0.38 | 50 |
| woven polyester | | | | |
| Polyester fleece | 14.63 | 152.81 | 0.4 | 50 |
| Linen sheet, white, (nro | 35.48 | 179.265 | 0.6 | 50 |
| 3118) Flax mat | | | | |
| Linen sheet, natural, (nro | 28.73 | 525.84 | 0.51 | 50 |
| 3322) Flax mat | | | | |
| Profillin NV, Flax mat | 29.295 | 479.5 | 0.49 | 50 |
| Textile (50% cotton + | 20.10 | 233.88 | 0.40 | 50 |
| 50% polyester) | | | | |

Table 3 shows the tensile strength (EN789) and modulus of elasticity (MOE) of different Colback S90 (non-woven synthetic polymer) laminates. The laminate consisted of a bottom and top film (specified in Table 5) and a middle layer of Colback S90, Flax material. The MOE was calculated from 10-40% of the maximum force. The cross-head distance was 10 mm and sample size 50×250 mm. The radiation sensitive film had much better tensile strength properties after radiation. The materials had varying mechanical properties. Laminates of the Profillin flax and HDPE in all of the film layers provided a laminate with MOE values similar to that of a birch veneer.

TABLE 3

| Bottom and top | | | |
|---|---|---|---|
| layer of the | | MOE | TS |
| laminate | Middle Layer | (N/mm²) | (N/mm²) |
| 2% MAPE + MI-0.3PE/ | Colback S90 | 366.2 | 18.9 |
| MI-0.3PE/ | | | |
| 2% MAPE + MI-0.3PE | | | |
| 2% MAPE + MI-0.3PE/ | Colback S90 | 481.5 | 21.4 |
| MI-0.2HDPE/ | | | |
| 2% MAPE + MI-0.3PE | | | |
| 2% MAPE + MI-0.3PE/ | Colback S90 | 467.1 | 21.3 |
| MI-0.4MDPE/ | | | |
| 2% MAPE + MI-0.3PE | | | |
| 3% MAPE + MI-0.2HDPE/ | Profillin NV, | 1021 | 41.4 |
| MI-0.2HDPE/ | Flax material | | |
| 3% MAPE + MI-0.2HDPE | | | |
| 2% MAPE + MI-0.3PE/ | Linen sheet, | 442.6 | 45.3 |
| MI-0.3PE/ | white, Flax | | |
| 3% MAPE + MI-0.3PE | material | | |
| 2% MAPE + MI-0.3PE/ | Linen sheet, | 720.9 | 43.5 |
| MI-0.2HDPE/ | natural, Flax | | |
| 3% MAPE + MI-0.3PE | material | | |

Table 4 shows the results for overlapping single flax fibers. The aim was to find the critical overlapping length (10 mm, 15 mm, 20 mm, 25 mm). It is clear from Table 4 that the minimum overlapping length is 20 mm since the strength and stiffness increases linearly from 10 mm -20 mm and then levels out after 20 mm.

TABLE 4

| Fibre overlapping distance | MOE | TS |
|---|---|---|
| (mm) | (N/mm²) | (N/mm²) |
| 10 | 8122 | 67.7 |
| 15 | 10158 | 76.1 |
| 20 | 11813 | 108.3 |
| 25 | 12643 | 111.9 |

Table 5 shows the tensile strength (EN789) and modulus of elasticity (MOE) of different single flax and jute fiber laminates. The laminate consisted of a bottom and top film (2% MAPE+MI-0.3PE/MI-0.3PE/3% MAPE+MI-0.3PE) and a middle layer of jute or flax fibers. The MOE was calculated from 10-40% of the maximum force. The cross-head distance was 10 mm and sample size 50×250 mm. The radiation sensitive film had much better tensile strength properties after radiation. It was clear that 50% fiber content was the limit before the mechanical properties start to decrease for both fiber types. In addition to this jute had better overall mechanical properties, this was owing to its better continuous length compare to flax.

TABLE 5

| | | |
|---|---|---|
| Fibre | TS | MOE |
| proportion (%) | (N/mm²) | (N/mm²) |

Jute

| | | |
|---|---|---|
| 35.77 | 68.36 | 9260.72 |
| 40.54 | 81.15 | 12467.64 |
| 42.11 | 73.17 | 13729.93 |
| 46.99 | 73.84 | 17047.23 |
| 51.11 | 100.60 | 18874.44 |
| 54.40 | 107.14 | 14252.19 |
| 56.44 | 116.07 | 16204.44 |

Flax

| | | |
|---|---|---|
| 30.52 | 100.32 | 9277.89 |
| 31.50 | 105.65 | 9042.32 |
| 35.46 | 120.15 | 9811.15 |
| 35.16 | 111.09 | 9772.33 |
| 43.29 | 128.90 | 10337.79 |
| 57.33 | 164.52 | 14157.57 |
| 72.88 | 139.75 | 10765.32 |

Table 6 shows the taber (EN14354) and impact resistance (SS 839123) results of various fiber reinforced laminate coatings. The laminate consisted of a bottom and top film (2% MAPE+MI-0.3PE/MI-0.3PE/3% MAPE+MI-0.3PE) and a middle layer (specified in Table 6). It was clear that the wear resistance (Taber results) and impact was improved by the coatings.

TABLE 6

| | | | | Impact resistance | |
|---|---|---|---|---|---|
| | Thickness | Taber (r), | | (small diameter | |
| Middle layer | (mm) | mm/1000 r | | ball test) | |
| Linas linen, | 0.46 | 0.085/5000 | r | 200 | mm |
| 100% linen | | | | | |
| Linen sheet, | 0.60 | 0.15/5000 | r | 200 | mm |
| white color, | | | | | |
| width 165 cm | | | | | |
| (nro 3118) | | | | | |
| Linen sheet, | 0.51 | 0.15/5000 | r | 100 | mm |
| natural color, | | | | | |
| width 100 cm | | | | | |
| (nro 3322) | | | | | |
| Lato linen, | 0.64 | 0.125/5000 | r | 100 | mm |
| 100% linen | | | | | |
| Single flax | 0.46 | 0.19/5000 | r | 200 | mm |
| fibre laminate | | | | | |
| WISA-form MDO | 0.4 | 0.3 mm/1000 | r | 10 | mm |
| WISA-form | 0.1 | 0.2 mm/1000 | r | 0 | mm |
| Spruce | | | | | |
| WISA-form Beto | 0.1 | 0.2 mm/1000 | r | 10 | mm |
| WISA-form 220 | 0.15 | 0.2 mm/1000 | r | 10 | mm |
| WISA-form | 0.2 | 0.2 mm/1000 | r | 25 | mm |
| Super | | | | | |
| WISA-form | 1.6 | 0.1 mm/1000 | r | 400 | mm |
| Elephant | | | | | |
| WISA-form | 1.6 | 0.1 mm/1000 | r | 400 | mm |
| Elephant U2 | | | | | |

| | | | | |
|---|---|---|---|---|
| WISA-form | 0.6 | 0.2 mm/1000 | r | — |
| Epoxy | | | | |

Table 7 shows bending strength and stiffness of panels containing reinforced jute and flax glue-line. Phenol foil was used as a reference value. 5 mm birch plywood was used with reinforced jute and flax laminates between each veneer. The laminate consisted of a bottom and top film (3% MAPE+MI-0.2HDPE/3% MAPE+MI-0.2HDPE/3% MAPE+MI-0.2HDPE) and a middle layer specified in Table 7. Hot-pressing was performed in conditions: 150° C. temperature, 0.5 N/mm² and 90 sec. It was clear that there was very little difference in bending strength and stiffness between jute and flax fibers. According to analysis, strength and stiffness (3-point bending strength and bending modulus) of 50% single fibre reinforced foil laminate was about same with a single birch veneer in longitudinal direction. The phenol bonded plywood was better when no fibers were used. This indicates the importance of wetting of the fibers by the matrix.

TABLE 7

| | Panel | Bending | Bending |
|---|---|---|---|
| | information | strength (N/mm²) | stiffness (N/mm²) |
| All veneers | Flax fibre | 19 | 881 |
| are in same | reinforced | | |
| direction | (Foil) | | |
| | Jute fibre | 18.5 | 742 |
| | reinforced | | |
| | (Foil) | | |
| | Flax fibre | 20.9 | 830 |
| | reinforced | | |
| | (Phenol foil) | | |
| | Jute fibre | 21.4 | 903 |
| | reinforced | | |
| | (Phenol foil) | | |
| | without fibre | 10.4 | 296 |
| | (Foil) | | |
| | without fibre | 28.8 | 1006.33 |
| | (Phenol foil) | | |
| All veneers | without fibre | 25 | 909.33 |
| are in cross | (Foil) | | |
| direction | without fibre | 38.9 | 1425.33 |
| | (Phenol foil) | | |

Table 8 shows bending strength and stiffness of panels containing reinforced flax glue-line. Phenol foil was used as a reference value. 7 ply birch plywood was used with reinforced flax laminates used between the two outer veneers either side of the plywood. The laminate consisted of a bottom and top film (3% MAPE+MI-0.2HDPE/3% MAPE+MI-0.2HDPE/3% MAPE+MI-0.2HDPE) and a middle layer specified in Table 8. Hot-pressing was performed in conditions: 140° C. temperature, 1.7 N/mm² and 580 sec.

TABLE 8

| | Bending strength | Bending modulus |
|---|---|---|
| Panel type | (N/mm²) | (N/mm²) |
| 1. Flax fibre reinforced | 31.5 | 2747 |
| 2. control panel 1 | 8.2 | 269 |
| 3. control panel 2 | 8.5 | 320 |

From the tests it was discovered that the material of the invention is a suitable reinforcement glue line material to be used as a glue line or as a coating in wood boards.

### EXAMPLE 2

In this example, stability of the glue-line material of the invention was tested.

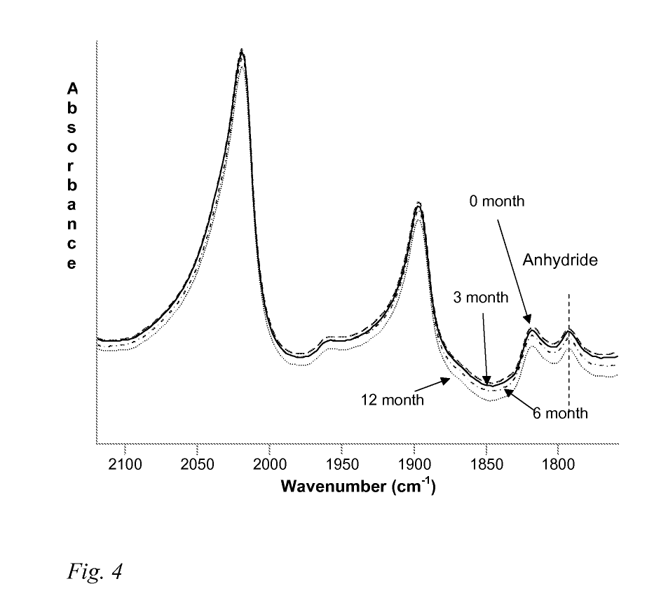

Tables 9 to 11 and FIG. 4 show and the conversion of maleic acid to maleic anhydride and its affect on the glue-line strength and the stability of the films after maleic anhydride is converted to the active state and contact angles of the polar groups face inwards.

Table 9 shows the conversion to maleic anhydride during film manufacturing of maleic anhydride grafted polyethylene (Fusabond MB-226DE) film 2% MAPE+PE/PE/2% MAPE+PE at different extrusion temperatures.

TABLE 9

| Treatment | Treatment | Maleic | Maleic | Coating glue-line |
|---|---|---|---|---|
| temperature | time | acid | anhy- | strength N/mm² (wood |
| (° C.) | (minutes) | (%) | dride (%) | failure %) After boiling |
| No | 3 | 55 | 45 | — |
| treatment | | | | |
| 170 | 3 | 36 | 64 | 0.17 (0%) |
| 180 | 3 | 20 | 80 | 0.31 (70%) |
| 185 | 3 | 14 | 86 | 0.34 (80-90%) |
| 190 | 3 | 10 | 90 | 0.36 (90-100%) |
| 195 | 3 | 8 | 92 | 0.36 (90-100%) |

It is clear from the results of Table 9 that the maleic acid is converted mostly to maleic anhydride at temperatures of 185° C. for 3 minutes and therefore it can be considered that during extrusion where the polymer is in the melt for about 2-3 minutes that an extrusion temperature of >185° C. is sufficient but preferably >190° C. The coating glue-line strength and percentage wood failure is on a similar level after boiling as for Wisa Multi-wall (0.4 N/mm², 80-90% wood failure) which also supports that conversion of maleic acid to maleic anhydride is sufficient at temperatures of >185° C.

Once the maleic acid is converted to maleic anhydride it is important to know how long the films will remain in the active state before enough moisture is absorbed and the maleic anhydride is converted back to maleic acid. Films containing the activated material were conditioned (humidity 65% and temperature 23° C.) for 1 month, 3 month, 6 month and month. The films were analysed by ATR-FTIR spectroscopy.

FIG. 4 and Table 10 show the ATR spectroscopy results comparing the maleic anhydride in the films (Table 9) extruded for 2-3 minutes at 200° C. it is clear that sufficient maleic acid is converted to maleic anhydride and therefore the extrusion temperature and processing time is sufficient. FIG. 4 shows ATR-FTIR spectra of 3 different films identified in Table 10 (45 degree Germanium ATR unit).

TABLE 10

| | Coupling | | |
|---|---|---|---|
| Film | agent | Film age | Film type |
| 2 | Fusabond | 1 year | 2% MAPE + PE/PE/2% MAPE + PE |
| 3 | MB226DE | 6 month | 2% MAPE + PE/PE/2% MAPE + PE |
| 4 | | 3 month | 2% MAPE + PE/PE/2% MAPE + PE |

The results revealed no change in the amount of maleic anhydride and spectra similar to film-4 in FIG. 4 resulted after each month for a total of 12 months. This shows the maleic anhydride is stable long-term when surrounded by polyethylene. This is owing to the low water absorption of polyethylene and also to the fact in the solid state the maleic acid groups will not be at the polymer surface but facing inwards and therefore shielded. The maleic groups are only facing outwards when the polymer is in the melt. This theory of the hydrophilic groups facing inwards is supported by the contact angle results in Table 11. Table 11 shows contact angles (receded and advanced) and surface free energy measured for different activated 3-layer co-extruded films by the pendent drop method. Two test liquids were used diiodomethane (DIM) and water. The maleated polymer films were compared with other polar group (EVA) containing films.

TABLE 11

| | | 2% MAPE + | 4% EVA + | 8% EVA + |
|---|---|---|---|---|
| | | PE/PE/2% | PE/PE/2% | PE/PE/8% |
| Film type | | MAPE + PE | EVA + PE | EVA + PE |
| Film thickness (mm) | | 0.27 | 0.27 | 0.27 |
| Average water | Advanced | 108.5 ± 0.6 | 98.8 ± 0.6 | 98.7 ± 1.6 |
| contact angle (°) | Receded | 89.6 ± 0.6 | 85..8 ± 0.6 | 83.0 ± 2.9 |
| Average DIM | Advanced | 57.1 ± 1.2 | 53.8 ± 0.6 | 49.0 ± 1.4 |
| contact angle (°) | Receded | 46.7 ± 0.8 | 43.4 ± 1.1 | 43.8 ± 1.3 |

| | | | |
|---|---|---|---|
| Surface free energy (mJm⁻²) | 38 | 40 | 41 |

A glue line material and a wood board according to the invention are suitable in their different embodiments for different types of applications.

The embodiments of the invention are not limited to the examples presented rather many variations are possible within the scope of the accompanying claims.

1. A glue line material for a wood board, wherein the glue line material is formed of at least first layer formed of a film, and the film comprises at least three film layers and at least outer film layers contain polyolefin and a coupling agent which is reactive with —OH groups of the wood for forming self-adhesive properties to make the glue line material self adhesive to —OH groups of the wood.

2. The material according to claim 1, wherein the glue line material comprises the top layer arranged on the first layer.

3. The material according to claim 2, wherein the glue line material comprises at least one middle layer arranged between the first and the top layers.

4. The material according to claim 1, wherein the glue line material comprises reinforcement fibers.

5. The material according to claim 4, wherein the glue line material comprises at least one reinforcement layer.

6. The material according to claim 1, wherein the film of the first layer is a multi-layer film containing more than three film layers.

7. The material according to claim 2, wherein the top layer is formed a film.

8. The material according to claim 3, wherein the middle layer is formed a film.

9. The material according to claim 7, wherein the film is a 2-layer film.

10. The material according to claim 7, wherein the film is a 3-layer film.

11. The material according to claim 1, wherein the top and/or middle layer contains polyolefin and the coupling agent.

12. The material according to claim 1, wherein the coupling agent is selected from the group maleic anhydride polyolefin.

13. The material according to claim 12, wherein maleic acid is converted to maleic anhydride during the film manufacturing so that maleic anhydride conversion is more than 86% and unconverted maleic acid conversion is less than 14%.

14. The material according to claim 1, wherein the first, top and/or middle layer contains polyethylene, polypropylene, high density polyethylene, medium density polyethylene, high molecular weight polyethylene, ultra high molecular weight polyethylene, maleic anhydride polyethylene, maleic anhydride polypropylene, metallocene produced polyethylene or their combinations.

15. The material according to claim 1, wherein the first, top and/or middle layer contains polyolefin having melt flow index in the range 0.1-4 g/10 min and DSC melting temperature in the range of 100-140° C.

16. The material according to claim 1, wherein the reinforcement layer contains polyolefin, coupling agent, metallocene produced polyethylene, woven textile, non-woven textile, woven fiber, non-woven fiber, oriented fiber material, non-oriented fiber material, organic fiber, glass fiber, carbon fiber, nylon 66, aramid, natural fiber, cotton, viscose-pulp, hemp fiber or their combinations.

17. The material according to claim 1, wherein the film is manufactured by co-extrusion, and the extrusion temperature is between 180-200° C. to activate the coupling agent during the film manufacturing.

18. A wood board, wherein the wood board comprises the glue line material according to claim 1, wherein.

19. The wood board according to claim 18, wherein the glue line material is arranged between the veneers of the wood board.

20. The wood board according to claim 18, wherein the glue line material is arranged on the surface of the wood board.
